(19) United States
(12) Patent Application Publication
(10) Pub. No.: US 2021/0401248 A1
(43) Pub. Date: Dec. 30, 2021

(54) VACUUM CLEANER AND FILTER ASSEMBLY

(71) Applicant: Dyson Technology Limited, Wiltshire (GB)

(72) Inventors: Kristian Richard Thomas KING, Bristol (GB); Thomas Douglas RIDLEY, Bristol (GB)

(73) Assignee: Dyson Technology Limited, Wiltshire (GB)

(21) Appl. No.: 17/292,274

(22) PCT Filed: Nov. 6, 2019
(86) PCT No.: PCT/GB2019/053141

§ 371 Date: May 7, 2021

(30) Foreign Application Priority Data
Nov. 9, 2018 (GB) 1818291.5

(51) Int. Cl. A47L 9/12; A47L 5/24; B01D 46/24; B01D 46/00; B01D 46/52; A47L 9/28; A47L 9/22; A47L 9/32

(52) U.S. Cl. CPC A47L 9/127; A47L 5/24; B01D 46/2403; B01D 46/0023; B01D 46/0002; B01D 46/521; B01D 2279/55; A47L 9/22; A47L 9/322; B01D 46/0043; B01D 2271/02; B01D 2273/30; A47L 9/2857

(57) ABSTRACT

A vacuum cleaner including a main body and a filter assembly. The main body includes a vacuum motor for drawing a flow of air through the vacuum cleaner. The filter assembly includes a first filter, and a filter housing configured to form part of an outer surface of the vacuum cleaner. The filter assembly defines a longitudinal axis, and a through-hole which runs along the longitudinal axis through the filter assembly. Also disclosed herein is a filter assembly for said vacuum cleaner.

### REFERENCE TO RELATED APPLICATIONS

This application is a national phase application under 35 USC 371 of International Application No. PCT/GB2019/053141, filed Nov. 6, 2019, which claims the priority of United Kingdom Application No. 1818291.5, filed Nov. 9, 2018, the entire contents of each of which are incorporated herein by reference.

### FIELD OF THE DISCLOSURE

The present invention relates to a vacuum cleaner which comprises a filter assembly, and a filter assembly for such a vacuum cleaner.

### BACKGROUND OF THE DISCLOSURE

Filters are key components in vacuum cleaners. Without filters, dirt and debris can enter the motor, reducing its efficiency and performance overtime. In addition, motors themselves can produce emissions in the form of particles which may be undesirable to be released into the atmosphere.

However, the addition of filters to a product can impact the size of the product, particularly if more than one filter is required in order to filter both upstream and downstream of a motor. In addition, filters typically require maintenance by a user, whether that be replacement or removal for cleaning.

### SUMMARY OF THE DISCLOSURE

It is an object of the invention to mitigate or obviate one of the above disadvantages, or to provide an improved or alternative filter assembly or vacuum cleaner.

According to a first aspect of the present invention there is provided a vacuum cleaner comprising a main body and a filter assembly, wherein:

the main body comprises a vacuum motor for drawing a flow of air through the vacuum cleaner;

the filter assembly comprises a first filter, and a filter housing configured to form part of an outer surface of the vacuum cleaner; and

wherein the filter assembly defines a longitudinal axis, and a through-bore which runs along the longitudinal axis through the filter assembly.

The through-bore can allow the filter assembly to fit around another component (for instance a vacuum motor), thereby reducing the overall axial length of the vacuum cleaner. Indeed, a component of the vacuum cleaner can project all the way through the filter assembly for the sake of compactness, with the end of this component nonetheless being visually or operably accessible, or can project part way into the through-bore with visual/manual access being provided by the remaining portion of the through-bore. Still further, the through bore can facilitate quicker and/or easier washing of the filter, as described later.

Providing a through-bore would be counter-intuitive in the mind of the skilled person, who would generally believe that it is preferable for a filter assembly to be as enclosed as possible so as to minimise the opportunity for leakage.

The filter housing being configured to form part of an outer surface of the vacuum cleaner may mean that the filter assembly is more easily accessed by a user (at which point filter maintenance may be easier). Furthermore, where at least part of the outer casing is transparent/translucent (as discussed below) then that part forming part of the outer surface of the vacuum cleaner can allow for easier visual access to the inside of the filter assembly.

For the avoidance of doubt, the term ‘through-bore’ is not intended to imply that the hole through the filter assembly is necessarily circular in cross section.

The filter assembly may further comprise a second filter.

By combining two filters into a single assembly, a more compact and convenient filter assembly can be achieved. Furthermore, a user is able to handle and interact with both filters simultaneously. For example, removing, replacing, washing or cleaning both the filters can be done in a single action instead of the user having to do so for each filter individually.

The first filter may be configured as a pre-motor filter and the second filter may be configured as a post-motor filter.

The advantages discussed above may be particularly prevalent where the two filters are pre-motor and post-motor filters, which are generally provided separately and often a considerable distance apart.

Optionally, the first and second filters do not overlap in the axial direction.

This can provide easier or lower loss ducting leading to and from the two filters, and/or improved radial compactness, for instance in contrast to an arrangement where the filters are nested within one another, at which point the filters must be spaced apart enough in the radial direction to provide space for ducting for the inner filter (such ducting being likely to introduce significant losses due to tight radii).

The cross sectional shape of one or both of the filters, when viewed along the longitudinal axis, may be generally annular.

For instance, one or both the filters may be substantially circular, elliptical, octagonal or obround when viewed along the longitudinal axis. Said one or both filters may be positioned circumferentially around the longitudinal axis.

Motors tend to have a generally cylindrical shape, and by providing the filters with a cross sectional shape that substantially matches that of the outside of the motor or motor housing, a particularly space-efficient filter can be achieved.

As an alternative, the filters may take an alternative shape. For instance, each filter may be arcuate and extend around the longitudinal axis through an angle considerably less than 360 degrees.

The filter housing may define a rim which runs around the through hole, the rim comprising an annular sealing member.

The annular sealing member can minimise leaking which could occur between the rim and a component of a vacuum cleaner that is received within the through-bore.

The housing may comprise an outer casing which encloses at least part of the second filter.

The outer casing can protect the second filter from knocks during use, and/or provide an area for a user to hold when manipulating the filter (thereby avoiding the user having to hold the second filter directly, which may damage the second filter and/or make the user's hands dirty).

The outer casing may comprise one or more vent holes through which air can be exhausted from the filter assembly.

This can provide an advantageously compact arrangement, and/or an arrangement with an advantageously simple or low-loss flow path (for instance where the second filter is a post-motor filter).

At least part of the outer casing may be transparent or translucent.

The outer casing being at least partially transparent/translucent can allow the user to view the second filter through the outer casing. The user can therefore check the condition of the filter (for instance to check for damage, or to check how soiled the filter is) simply by looking through the outer casing. Further, the filter being visible to the user during use can remind them of the need to wash the filter intermittently, whereas if the filter were completely concealed then it may be easier for the user to forget the need to maintain it.

The through-bore of the filter assembly preferably runs substantially parallel to, for instance substantially collinear with, the longitudinal axis.

The filters may be permanently mounted within the filter assembly. In other words, the filters may be configured to remain in place on the filter assembly during normal use, rather than being configured for intermittent removal therefrom. The filter assembly may therefore remain as a single unit, mitigating the risk of a component thereof becoming loose or being lost.

The filters may be axially adjacent to one another. This can reduce the axial length of the filter assembly in comparison to an arrangement where the filters are spaced apart in the axial direction.

The first and/or second filters may be arranged for air flow to pass through them in a generally radial direction. This may allow sufficient cross sectional area of filter to be provided in relatively little radial space, in contrast to an arrangement where fluid flow was in the axial direction.

The filter housing may comprise an exposed portion and an enclosed portion. The exposed portion of the filter housing may comprise a frame extending from the enclosed portion, the first filter being positioned around the frame.

The exposed portion can allow for efficient fluid flow to and around the pre-motor filter, which can provide more even loading of the flow around the filter. The enclosed portion can allow a part of the filter assembly to remain enclosed such that a user can hygienically handle the filter assembly by the enclosed portion without getting filtered dirt or dust on their hands.

The first filter may comprise a layered filter medium, and/or the second filter may be a pleated filter.

The filter housing may comprise an annular seal between the first and second filters. The seal can ensure that there is no fluid leakage around the housing between the pre- and post-motor filters. Any such fluid leakage around the housing could reduce the performance of a motor positioned within the filter assembly.

The flow direction for the first filter may be opposite to the flow direction for the second filter. As a result, there can be an efficient fluid flow through the filter assembly which minimises any changes of direction for the fluid flow (which can have a negative impact on efficiency and performance of a machine).

The flow direction for the first filter may be radially inwards towards the longitudinal axis, and the flow direction for the second filter may be radially outwards away from the longitudinal axis. As a result, the filter assembly can conveniently be positioned around a motor positioned along the longitudinal axis, maximising the use of space, while providing efficient filtration of fluid flowing into and out of the motor.

The vacuum cleaner may further comprise an electronic visual display, the electronic visual display projecting through or being visible through the through-bore of the filter assembly.

This may allow both the filter assembly and the electronic visual display to be located in the same area of the vacuum cleaner (for instance a particularly clearly visible and/or easily accessible area) without the electronic visual display needing to be mounted on the user-removable component (which may complicate the power and/or data supply to the electronic visual display). Instead or as well, the filter assembly surrounding the electronic visual display may protect the display from knocks.

The electronic visual display is preferably a screen, for instance an LCD screen such as a TFT screen, an LED screen such as an OLED screen, or any other suitable type of screen such as an ‘e-paper’ screen.

The filter assembly may be positionable to receive at least part of the vacuum motor inside the through-bore.

This may provide an advantageously compact arrangement. Instead or as well, the filter assembly may provide structural support for the vacuum motor so as to make the vacuum cleaner more rugged.

The filter assembly may be positioned around the vacuum motor such that the first filter is positioned around an inlet to the motor, and the second filter may be positioned around an outlet of the motor. As a result, fluid passes through the pre-motor filter directly into the inlet to the motor, and air leaving the motor passes directly through the post-motor filter.

The motor may be housed inside a motor bucket of the main body, the motor bucket projecting through the through-bore of the filter assembly.

The motor bucket projecting through the through-bore, rather than merely into the through bore, can take advantage of the full space available within the filter assembly, thereby allowing the vacuum cleaner as a while to be more compact.

Where the filter assembly comprises one or more sealing members, these sealing members may engage (for example slidingly engage) the motor bucket.

The motor bucket may be generally cylindrical. It may have a motor bucket inlet and a motor bucket outlet, the first filter being positionable around the motor bucket inlet and the second filter being positionable around the motor bucket outlet. The filter assembly may be positioned around the motor bucket and be removable from the vacuum cleaner by sliding the filter assembly over the motor bucket along the longitudinal axis of the filter assembly. As a result, the filter assembly can be quickly and easily removed from the motor bucket, and maintenance of the filters is more convenient for a user.

The motor bucket inlet may comprise a plurality of through-bores aligned with the inlet of the motor, and the motor bucket outlet may comprise a plurality of through-bores aligned with the outlet of the motor. As a result, the through holes allow fluid to flow easily through the motor bucket, without unnecessarily compromising the structural integrity of the motor bucket.

The filter housing may comprise an annular seal between the first and second filters, the annular seal being in sealing contact with a solid central portion of the motor bucket between the motor bucket inlet and motor bucket outlet. As a result, the seal can ensure that there is no fluid leakage around the housing between the motor bucket inlet and motor bucket outlet. Any such fluid leakage around the housing could reduce the performance of the motor, and as a result the performance of the product.

The vacuum cleaner may be a handheld or stick vacuum cleaner which further comprises:

a pistol grip which is positioned generally transverse to a longitudinal axis of the vacuum cleaner which runs from a front end to a rear end thereof; and

an air inlet positioned forward of the pistol grip, wherein the filter assembly is positioned at the rear of the vacuum cleaner.

The filter assembly being positioned at the rear of the vacuum cleaner means that in normal use of the vacuum cleaner the filter assembly is positioned close to the user. This, in turn, can make the filter assembly (for instance a transparent/translucent part of the outer casing), or components received within or projecting through the through-bore (for example the motor bucket or an electronic visual display), easier to access or easier to see during normal use.

The filter assembly may be removably mounted to the main body.

This can allow the filter to be washed or replaced intermittently so as to improve its performance (by removing clogs of dirt so as to reduce flow restriction).

The filter assembly may be attachable to the main body via a screw thread, through interlocking lugs, via an interference fit or ‘snap fit’, or in any other suitable fashion.

The filter assembly may be removable by moving it in an axial direction, for instance axially rearwards.

### BRIEF DESCRIPTION OF THE DRAWINGS

In order that the present invention may be more readily understood, embodiments of the invention will now be described, by way of example, with reference to the following accompanying drawings, in which:

FIG. 1 is a filter assembly useful for understanding the invention;

FIG. 2 is a cross section through the filter assembly of FIG. 1;

FIG. 3 shows the filter assembly of FIGS. 1 and 2 partially disassembled;

FIG. 4 shows a motor assembly and the filter assembly of FIG. 1;

FIG. 5 shows a cross section through the motor and filter assemblies of FIG. 4;

FIG. 6 shows the assemblies of FIG. 5, with the filter assembly assembled in place around the motor assembly;

FIG. 7 shows a handheld vacuum cleaner comprising the filter assembly of the previous figures;

FIG. 8 shows part of the vacuum cleaner of FIG. 7 during removal and reinstallation of the filter assembly;

FIG. 9 shows a stick vacuum cleaner according to a first embodiment of the invention;

FIG. 10 shows a handheld vacuum cleaner which forms part of the stick vacuum cleaner of FIG. 9;

FIG. 11 shows the handheld vacuum cleaner of FIG. 10, with a filter assembly detached therefrom;

FIG. 12 shows a filter assembly according to a second embodiment of the invention; and

FIG. 13 shows the filter assembly of FIG. 12 from a different angle.

### DETAILED DESCRIPTION OF THE DRAWINGS

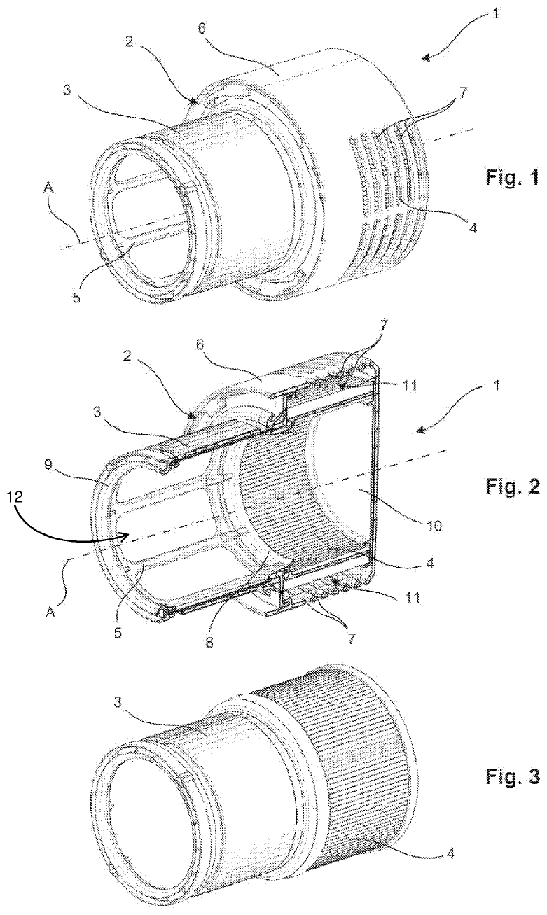

FIG. 1 shows a filter assembly 1, and FIG. 2 shows a cross section through the same filter assembly 1. FIG. 3 shows part of the filter assembly 1 where some components are not shown. Referring to these figures in combination, the filter assembly 1 comprises a filter housing 2 to which are fixed two filters: a first filter which takes the form of a pre-motor filter 3, and second filter which takes the form of a post-motor filter 4. The filter housing 2 defines a longitudinal axis A of the filter assembly 1. The pre-motor filter 3 and the post-motor filter are both annular in cross section when viewed along the longitudinal axis A, and both are positioned concentrically around the longitudinal axis A. The longitudinal axis A therefore forms a common axis for the filters 3, 4. The pre-motor filter 3 is positioned axially adjacent the post-motor filter 4, with little room between the two so as to minimise the overall size of the filter assembly 1. The two filters 3, 4 do not axially overlap, however.

The pre-motor filter 3 can be formed of any suitable filter material, or combination of materials, typically found in pre-motor filters. In this case the pre-motor filter 3 comprises layers of filter media including a layer of scrim or web material, a non-woven filter medium such as fleece, followed by a further layer of scrim or web material. An electrostatic filter medium could also be included if desired. The post-motor filter 4 can similarly be formed of any suitable filter material, or combination of materials, typically found in post-motor filters. In the present case, the post-motor filter 4 is formed of a pleated HEPA-standard (high efficiency particulate air) filter medium.

The filter housing consists of two identifiably distinct areas, an exposed portion and an enclosed portion. The exposed portion of the filter housing 2 has a frame 5 which extends from the enclosed portion of the filter housing 2. The pre-motor filter 3 is positioned around the frame 5 of the exposed portion of the frame 5. The frame 5 acts to support the pre-motor filter 3 such that it maintains its annular shame when the filter assembly 1 is in use. The enclosed portion of the filter housing 2 has an outer casing 6 (not shown in FIG. 3) which encloses the post-motor filter 4. The outer casing 6 has a number of vent holes 7, or apertures, through which fluid such as air is able to flow out of the filter assembly 1. The vent holes 7 therefore act as the outlet of the filter assembly 1. In FIG. 1, the post-motor filter 4 is partially visible through the vent holes 7 in the outer casing 6 of the filter housing 2.

The filter housing 2 also comprises an annular seal 8 positioned generally between the pre-motor filter 3 and the post-motor filter 4, inside the filter assembly 1. A further annular seal 9 is provided at one axial end of the filter housing at the opposite end of the pre-motor filter 3 from the post-motor filter 4. The annular seals 8 and 9 act to seal with a motor assembly when the filter assembly 1 is use, as explained in more detail later.

The outer casing 6 has a solid end wall 10, and the post-motor filter 4 is fixed inside the outer casing 6 in a position such that an annular cavity 11 is defined between the post-motor filter 4 and the outer casing 6. The annular cavity may simply be a void, as shown in the FIG. 2, or the annular cavity could be used to house another material such as sound-absorbing foam.

With the pre-motor filter 3, post-motor filter 4, frame 5 and most of the axial length of the outer casing 6 all being annular in shape, the filter assembly 1 defines a blind bore 12 which runs along the longitudinal axis A and terminates at the end wall 10. More particularly, since the pre-motor filter 3, post-motor filter 4, frame 5 and most of the outer casing 6 are positioned concentrically around the longitudinal axis A, the blind bore 12 runs collinearly with respect to the longitudinal axis A.

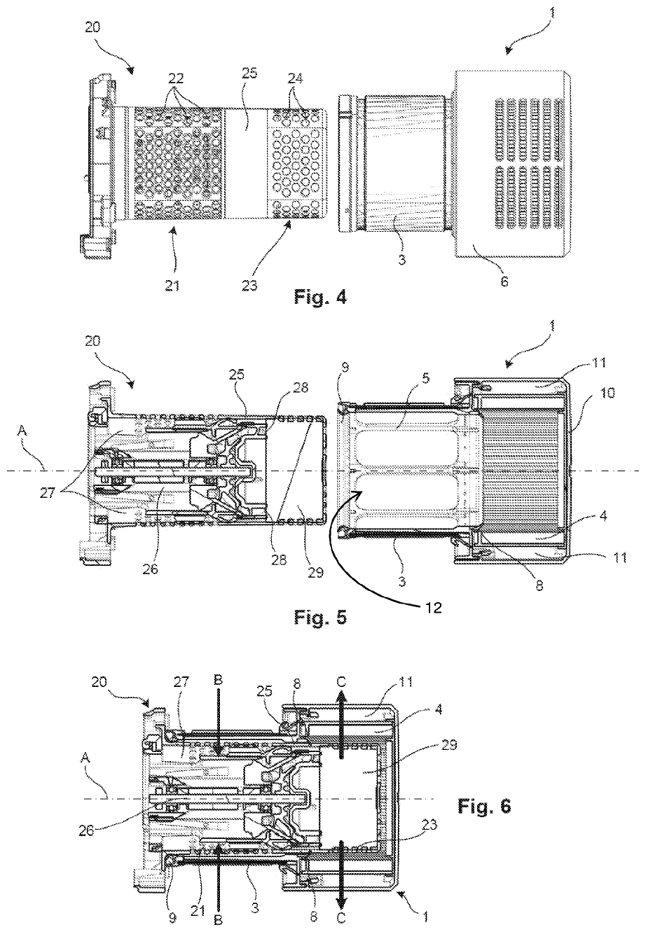

FIG. 4 shows the filter assembly 1 and a motor assembly comprising a cylindrical motor bucket 20, and FIG. 5 shows a cross section through the filter assembly 1 and motor assembly of FIG. 4. FIG. 6 shows the assemblies of FIG. 5, with the filter assembly 1 in place around the motor assembly.

The motor assembly comprises a motor bucket 20 having a motor bucket inlet 21 comprising a plurality of through-bores 22 acting as an inlet to a vacuum motor, and a motor bucket outlet 23 comprising a plurality of similar through-bores 24 acting as an outlet from the vacuum motor. A central portion 25 of the motor bucket separates the motor bucket inlet 21 and motor bucket outlet 23.

The vacuum motor 26 is located inside the motor bucket 20. The motor inlet 27 is aligned with the motor bucket inlet 21, and the motor outlet 28 is aligned with the motor bucket outlet 23. A cavity 29 between the motor outlet 28 and the motor bucket outlet 23 can house, for example, an open cell acoustic foam in order to provide further acoustic dampening benefits.

Whilst FIGS. 5 and 6 show the filter assembly 1 separated from the motor assembly, FIG. 6 shows the filter assembly in position around the motor assembly. The blind bore 12 of the filter assembly 1 fits over the motor bucket 20 such that it over overlaps with the motor 26 in a direction along the longitudinal axis A. The filter assembly 1 is therefore positioned around the motor 26, with the pre-motor filter 3 positioned around the motor bucket inlet 21 and the post-motor filter 4 positioned around the motor bucket outlet 23. Both the pre-motor filter 3 and the post-motor filter 4 axially overlap with the vacuum motor 26—the entire axial length of the pre-motor filter 3 axially overlaps the vacuum motor, and around 15% of the axial length of the post-motor filter axially overlaps the vacuum motor. The filter assembly 1 is removable and replaceable over the motor assembly by sliding the filter assembly 1 over the motor bucket 20 rearwards along the direction of the longitudinal axis A.

During operation, the vacuum motor 26 draws air through the pre-motor filter 3 as indicated by the arrow B. The air then flows into the motor bucket 20 via the through-bores 22 in the motor bucket inlet 21, and through the vacuum motor 26. After the fluid exits the motor outlet 28, it passes back out of the motor bucket 20 via the through-bores 24 in the motor bucket outlet 23, through the post-motor filter 4, and exits the filter assembly 1 via the vent holes 7 in the outer casing 6, as represented by arrow C. As is evident from FIG. 6, the fluid directions into and out from the filter assembly 1, represented by arrows B and C respectively, are opposite to each other. The flow direction for the pre-motor filter 3 is radially inwards in a direction towards the longitudinal axis A, and the flow direction for the post-motor filter 4 is radially outwards in a direction away from the longitudinal axis A.

The annular seal 8 seals against the central portion 25 of the motor bucket 20 such that any fluid flow within the filter assembly 1 between the inlet and the outlet is prohibited. The further annular seal 9 seals with another part of the motor bucket 20 on the opposite side of the motor bucket inlet 21 to the annular seal 8. The annular seals 8 and 9 therefore seal the filter assembly 1 on each side of the motor bucket inlet 21 to ensure that no fluid is able to leak around the filter assembly 1, which could reduce the performance and efficiency of the motor 26 (and thus of any product containing the vacuum motor 26).

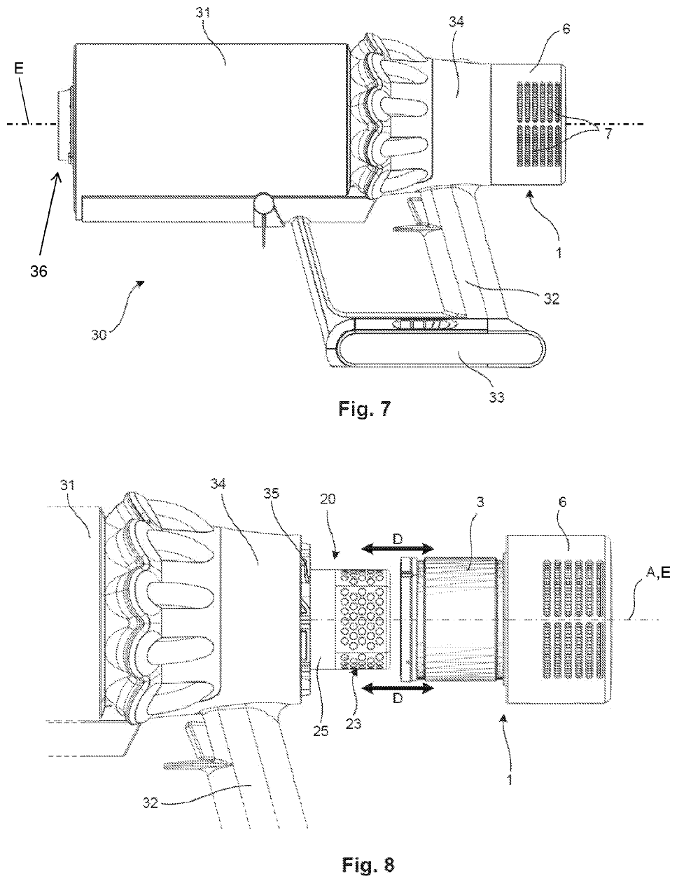

FIG. 7 shows a vacuum cleaner 30 comprising the filter assembly 1 and the motor assembly of the previous figures. The vacuum cleaner 30 is of the handheld type, although the filter assembly is not limited for use with handheld vacuum cleaners. The vacuum cleaner 30 has a dirt separator 31, a handle in the form of a pistol grip 32, a power source in the form of a battery pack 33, a main body 34 which comprises the motor assembly described above, and an inlet 36 through which air is drawn into the vacuum cleaner 30. The dirt separator 31 separates dirt from a dirt-laden airflow that is drawn into the vacuum cleaner, through the inlet 36, by a motor which is housed within the main body 34 and powered by the battery pack 33. After passing through the motor, cleaned air is expelled from the vacuum cleaner 30 through the vent holes 7 in the outer casing 6 of the filter assembly 1.

The vacuum cleaner 30, more particularly in this case the main body 34, dirt separator 31, motor assembly and inlet 36 in combination, define a longitudinal axis E of the vacuum cleaner. The longitudinal axis extends from a front of the vacuum cleaner 30 to a rear, with the inlet 36 being positioned at the front and the filter assembly 1 positioned at the rear. With the filter assembly 1 in place on the motor bucket 20, the longitudinal axis A of the filter assembly 1 is collinear with the longitudinal axis E of the vacuum cleaner 30.

The outer casing 6 of the filter assembly 1 forms part of the outer surface of the product (more particularly, in this case the end wall 10 forms a rearward-facing outer surface of the vacuum cleaner, and the remainder of the outer casing 6 forms part of a circumferential outer surface of the vacuum cleaner 30). This makes it easy for a user to handle the filter assembly, for example during maintenance of the filter assembly when the user may be required to remove the filter assembly from the vacuum cleaner. In addition, the air leaving the filter assembly is expelled directly into the atmosphere, and no additional ducting is required.

FIG. 8 shows removal and/or replacement of the filter assembly 1 from the vacuum cleaner 30 of FIG. 7. As indicated by the double arrows D, the filter housing 1 is removed from, and subsequently reassembled onto, the vacuum cleaner by sliding the filter assembly over the motor bucket 20 along the direction of the longitudinal axes A, E. The motor bucket outlet 23 can be seen in FIG. 8, but the motor bucket inlet is positioned inside the main body 34. The main body 34 has an annular recess around the motor bucket 20 such that the exposed portion of the filter assembly 1, which comprises the pre-motor filter 3, is able to slide inside the main body 34 into position around the motor bucket inlet.

A lug 35 or catch, or other temporary fixing means, is provided on the main body 34 of the vacuum cleaner 30 to lock the filter assembly 1 in place to prevent it from sliding off while the vacuum cleaner 30 is in use. There is a corresponding lug or engagement member on the filter housing of the filter assembly (not shown) which engages with the catch 35 on the main body 34. Rotation of the filter assembly 1 is required to engage the engagement member with the catch. Alternative temporary fixing means could be used instead of the catch 35. For example, the filter assembly 1 could be held in place on the vacuum cleaner 30 by way of a magnetic engagement.

The filter assembly 1 of this arrangement is intended to be washed intermittently during its lifetime, to remove dirt buildup on the pre-motor filter 3 and/or post-motor filter 4. In this case the filer assembly 1 is washed by holding it under a tap—the pre-motor filter 3 is washed by holding the filter assembly 1 horizontally under a stream of water and rotating it while massaging the pre-motor filter 3 to release dirt therefrom, and the post-motor filter 4 is washed by repeatedly filling up the space inside the outer casing 6 with water (by holding the filter assembly under the tap with the end wall positioned downwards) and upending the filter assembly to pour that water out.

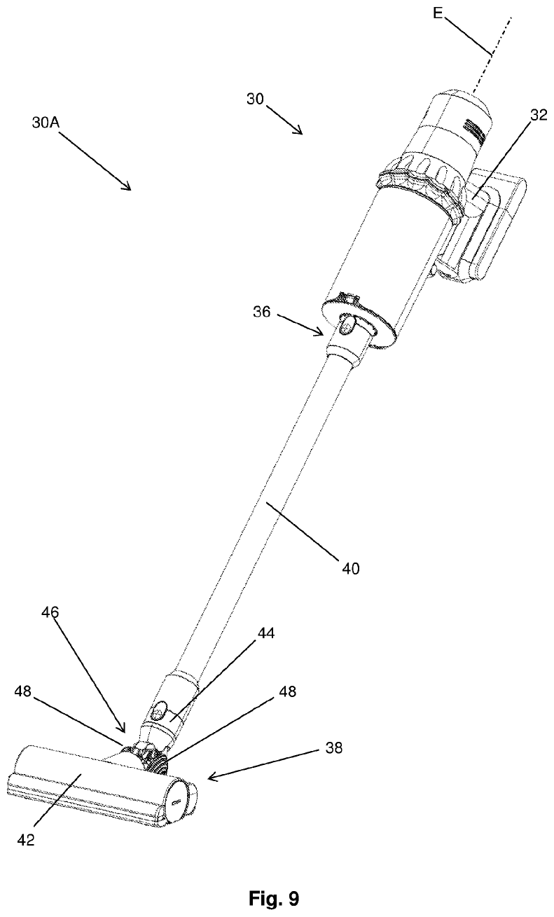

A vacuum cleaner 30A according to an embodiment of the invention is shown in FIG. 9. The vacuum cleaner 30A of this embodiment is a stick vacuum cleaner which comprises a handheld vacuum cleaner 30, a cleaner head 38 and an elongate rigid wand 40 which connects the cleaner head 38 to the handheld vacuum cleaner 30. The handheld vacuum cleaner 30 of this embodiment is generally the same as the handheld vacuum cleaner of the preceding figures, therefore only the differences will be described here.

The cleaner head 36 has a floor-engaging suction opening (not visible) through which air can enter the cleaner head in known fashion. The wand 40 is hollow and provides fluid communication between the cleaner head 38 and the inlet 36 of the handheld vacuum cleaner 30. The wand 40 extends along (in this case collinear with) the longitudinal axis E of the handheld vacuum cleaner 30. The cleaner head 38 has a casing 42 and outlet duct 44 which is rotatable relative to the casing 42 about a horizontal axis. The outlet duct 44 has a hinge joint 46 and a pair of domed wheels 48.

In operation, a user grips the pistol grip 32 of the handheld vacuum cleaner 30 with the rear of the handheld vacuum cleaner facing towards them and the front facing away from them and generally downwards. The wand 40 extends towards the floor and the cleaner head 38 rests on the floor, taking some of the weight of the stick vacuum cleaner 30A. The user ‘points’ the front of the handheld vacuum cleaner 30 towards an area of floor which they wish to clean, and through the rigid connection provided by the wand 40 the cleaner head is moved towards that area of floor. In this case, the user can also ‘steer’ the cleaner head by rotating the handheld vacuum cleaner 30A about its longitudinal axis E. The wand 40 transmits this rotation to the outlet duct 40, causing that to rotate about the longitudinal axis E as well. The outlet duct 40 therefore rotates relative to the casing 42, banks the wheels 48 and bends at the hinge joint 46. This causes the casing 42 of the cleaner head 38 to be redirected, rotating it in a horizontal plane while remaining in contact with the floor.

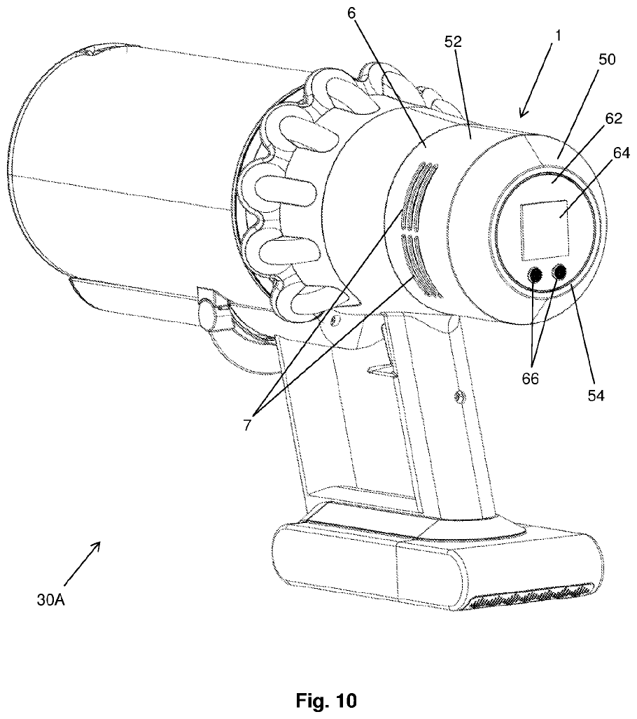

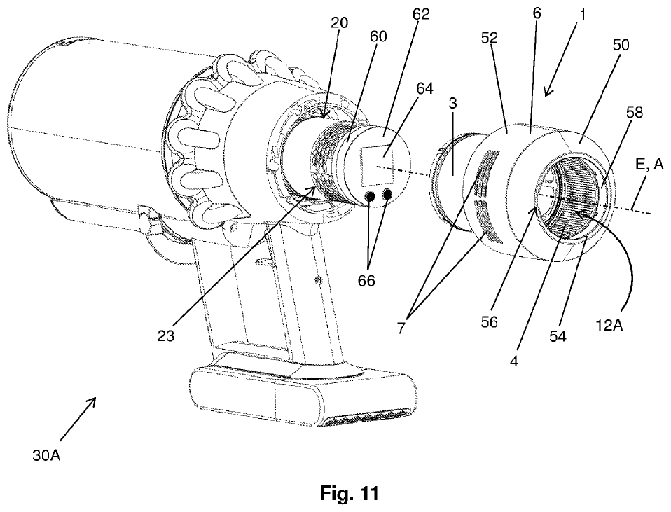

The handheld vacuum cleaner 30A of this embodiment is shown in FIGS. 10 and 11. These figures show ways in which this handheld vacuum cleaner 30A differs from the one described above.

The filter assembly 1 of this embodiment differs from that described above in that it has a through-bore 12A rather than a blind bore. The through-bore extends collinear with the longitudinal axis of the filter assembly 1, like the filter assembly described above, but in this case the through hole runs all the way through the filter assembly 1 rather than terminating at an end wall. The filter assembly 1 of this embodiment also differs in that it has a chamfer surface 50 which intersects a circumferential wall 52 and an annular end wall 54. The annular end wall 54 nonetheless forms part of a rearward-facing outer surface of the vacuum cleaner, as the end wall 10 of the previous arrangement did. The end wall 54 which encircles the through-bore 12A and forms a rim 56. The rim 56 includes a further annular seal 58.

The handheld vacuum cleaner 30 of this embodiment also differs in that the motor bucket 20 has a non-perforated axial end which has a circumferential wall 60 and an end wall 62. The end wall 62 supports a screen 64, more particularly a planar, full colour, backlit TFT screen. The end wall 62 also supports a pair of control members in the form of buttons 66. The screen 64 and buttons 66 face rearwards, with the screen being perpendicular to the longitudinal axis E and the lines of action of the buttons being parallel to the longitudinal axis E, for visibility and accessibility during use.

In this embodiment, the entire axial length of the through-bore 12A receives the motor bucket. The screen 64 and buttons 66 are therefore surrounded by the filter assembly 1, but project through the through-bore 12A such that they stand slightly proud of the end wall 54. In other embodiments, however, the motor bucket 20 may extend only part way into the through-bore 12A such that the screen is recessed behind the end wall 54 and visible through the through-bore 12A (and such that the buttons 66 are visible through and operable through the through-bore 12A).

With the filter assembly 1 in position around the motor bucket 20, the annular seal 58 engages the circumferential wall 60 of the non-perforated axial end of the motor bucket 20. Accordingly, air exiting the motor bucket 20 through the motor bucket outlet 23 cannot leak out between the motor bucket 20 and the rim 56 and must instead pass through the post-motor filter 4 and out of the vent holes 7.

The filter assembly 1 of this embodiment is intended to be washed, as with that of the arrangement described above. The pre-motor filter 3 is washed in the same manner as described above, but due to the through-bore 12A there is no need to repeatedly fill up and empty the space inside the outer casing 6 so as to wash the post-motor filter 4. The filter assembly 1 can simply be held at an angle under a tap so that the stream of water flows into the through-bore 12A, impinges on the inside of the post-motor filter, then flows out of the other end of the through-bore. Furthermore, if necessary the user can reach their fingers into the rear end of the through-bore 12A so as to agitate the post-motor filter 4. Washing of the filter assembly 1 of this embodiment can therefore be quicker and/or more effective.

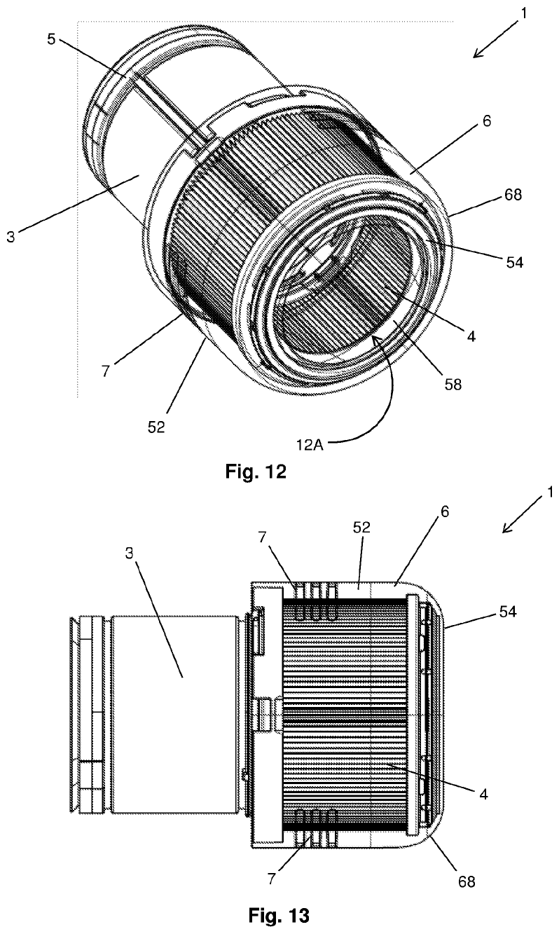

FIGS. 12 and 13 show a filter assembly 1 according to another embodiment of the invention. The filter assembly 1 of this embodiment is generally the same as that of FIGS. 9-11, and indeed can be used in place of that filter assembly in the handheld vacuum cleaner 30, therefore only the differences will be described here.

In this case the outer casing 6 of the filter assembly is transparent. This allows the post-motor filter 4 to be viewed through the outer casing 6, rather than only being visible by peering through the vent holes 7 or removing the outer casing 6 from the frame 5. Since in this case the entire outer casing 6 is transparent, the parts of both the rearward-facing surface and the circumferential surface which are defined by the outer casing 6 are transparent.

The filter assembly 1 of this embodiment also differs from that of the previous embodiment in that it has a fillet surface 68, rather than a chamfer surface, between the circumferential wall 52 and an annular end wall 54. This can improve the aesthetics of the filter assembly 1 (and thus of the handheld vacuum cleaner), can make the filter assembly 1 easier to wash or dry if required, and/or can improve air flow through the filter assembly.

Whilst particular embodiments have thus far been described, it will be understood that various modifications may be made without departing from the scope of the invention as defined by the claims. For example, in the embodiments described above, the pre- and post-motor filters have a circular cross-sectional shape. However, in alternative embodiments, other cross-sectional shapes may be adopted. For example, the cross-sectional shape of the pre- and post-motor filters may be elliptical, obround, square, horseshoe-shaped or rectangular. Furthermore, whilst the embodiments described above all show the pre-motor filter and the post-motor filter both having the same cross-sectional shape, it will be understood that in alternative embodiments, the pre-motor filter may have a different cross-sectional shape to the post-motor filter. The shapes of the pre-motor filter and post-motor filter, and as such the filter assembly in which they are housed, can therefore be adapted to the requirements of the vacuum cleaner in which they are being used.

Furthermore, although the arrangements and embodiments described above have had either transparent outer casings or opaque outer casings, it is to be understood that a filter assembly according to the invention may be translucent, or may be opaque with a transparent/translucent window therein.

For the avoidance of doubt, the optional and/or preferred features described above may be utilised in any suitable combinations, and in particular in the combinations set out in the appended claims. Features described in relation to one aspect of the invention may also be applied to another aspect of the invention, and/or features described in relation to an arrangement useful for understanding the invention may also be applied to an aspect of the invention, where appropriate.

1. A vacuum cleaner comprising a main body and a filter assembly, wherein:
the main body comprises a vacuum motor for drawing a flow of air through the vacuum cleaner;
the filter assembly comprises a first filter, and a filter housing configured to form part of an outer surface of the vacuum cleaner; and
wherein the filter assembly defines a longitudinal axis, and a through-bore which runs along the longitudinal axis through the filter assembly.

2. The vacuum cleaner of claim 1, wherein the filter assembly further comprises a second filter.

3. The vacuum cleaner of claim 2, wherein the first filter is configured as a pre-motor filter and the second filter is configured as a post-motor filter.

4. The vacuum cleaner of claim 2, wherein the first and second filters do not overlap in the axial direction.

5. The vacuum cleaner of claim 2, wherein the cross sectional shape of one or both of the filters, when viewed along the longitudinal axis, is annular.

6. The vacuum cleaner of claim 1, wherein the filter housing defines a rim which runs around the through hole, the rim comprising an annular sealing member.

7. The vacuum cleaner of claim 1, wherein the housing comprises an outer casing which encloses at least part of the second filter.

8. The vacuum cleaner of claim 7, wherein the outer casing comprises one or more vent holes through which air can be exhausted from the filter assembly.

9. The vacuum cleaner of claim 7, wherein at least part of the outer casing is transparent or translucent.

10. The vacuum cleaner of claim 1, further comprising an electronic visual display, the electronic visual display projecting through or being visible through the through-bore of the filter assembly.

11. The vacuum cleaner of claim 1, wherein the filter assembly is positionable to receive at least part of the vacuum motor inside the through-bore.

12. The vacuum cleaner of claim 11, wherein the motor is housed inside a motor bucket of the main body, the motor bucket projecting through the through-bore of the filter assembly.

13. The vacuum cleaner of claim 1, wherein the vacuum cleaner is a handheld or stick vacuum cleaner which further comprises:
a pistol grip which is positioned transverse to a longitudinal axis of the vacuum cleaner which runs from a front end to a rear end thereof; and
an air inlet positioned forward of the pistol grip,
wherein the filter assembly is positioned at the rear of the vacuum cleaner.

14. The vacuum cleaner of claim 9, wherein the filter assembly is removably mountable to the main body.

15. A filter assembly for a vacuum cleaner of claim 1.
